(19) United States
(12) Patent Application Publication
(10) Pub. No.: US 2002/0153833 A1
(43) Pub. Date: Oct. 24, 2002

(54) Full-color electroluminescent lamp and manufacturing method for same

(76) Inventor: Alvin Wu, Kaohsiung (TW)

Correspondence Address: DOUGHERTY & TROXELL, SUITE 1404, 5205 LEESBURG PIKE, FALLS CHURCH, VA, 22041, US

(21) Appl. No.: 09/836,293

(22) Filed: Apr. 18, 2001

(51) Int. Cl. H01J 1/62

(52) U.S. Cl. 313/506

(57) ABSTRACT

A full-color electroluminescent lamp consists of an upper protective film, a light-emitting film, and a bottom protective film. The light-emitting film serving as the light source of the full-color electroluminescent lamp is sandwiched between the upper protective film and the bottom protective film. The light-emitting film at least includes a face electrode substrate, a face electrode layer, a phosphor layer, and a back electrode layer. At least one full-color pattern is formed on one of the inner surfaces of the electroluminescent lamp by full-color printing method (for example, an image might be printed on the inner surface of the upper protective film) and is illuminated by the light-emitting film. This full-color electroluminescent lamp is thinner, provides better graphic resolution, and suffers less brightness loss while emitting light to display the full-color pattern.

### BACKGROUND OF THE INVENTION

1. Field of the Invention

The present invention relates to a full-color electroluminescent lamp and the manufacturing method for the same, wherein the electroluminescent lamp, with the addition thickness of only one layer of colored pigment, is capable of providing a full-color image of high resolution and brightness.

2. Description of the Prior Art

As shown in FIG. 1, a common electroluminescent lamp (10) generally includes a transparent upper protective film (11), a bottom protective film (13), and a light-emitting film (12) sandwiched between them. The light-emitting film (12) serves as the light source of the electroluminescent lamp (10) and can be further divided into components, in order, of a face electrode substrate (121), a face electrode layer (122), a phosphor layer (123), a dielectric layer (124), and a back electrode layer (125). The face electrode substrate (121) is made of transparent plastic material (e.g., PET (Polyethylene terephalate)) and serves as the basis for supporting the face electrode layer (122). The face electrode layer (122) is made of transparent electricity-conductive material (e.g., ITO (Indium Tin Oxide)), while the phosphor layer (123) can be made of light emitting materials of organic compounds (e.g., PPV, CN-PPV, PVK, etc.) or inorganic compounds (e.g., ZnS, silicates, phosphates, tungstate, oxisfulfotes, etc.) The back electrode layer (125) is an electricity-conductive material (e.g., conductive paste, aluminum foil). The phosphor layer (123) is located between the face electrode layer (122) and the back electrode layer (125) and emits light with the electricity field reaction generated by the alternating current voltage between the two electrode layers. There is usually also a dielectric layer (124) between the face electrode layer (122) and the back electrode layer (125). The dielectric layer (124) is better located between the back electrode layer (125) and the phosphor layer (123) to avoid short circuit between the electrode layers (122) and (125). The upper protective film (11) and bottom protective film (13), manufactured from PET, PVC or transparent plastic materials with similar properties, provide protection against oxidization of the light-emitting film (12). It can also prevent humidity and dust invasion and provides an appropriate structural strength. The general approach to manufacturing an electroluminescent lamp (10) is to apply adhesive layers (111) and (131) to the inner surfaces of the upper protective film (11) and the bottom protective film (13) respectively, and to sandwich the light-emitting film (12) between the two. The components are compressed by being passed between the upper roller (21) and bottom roller (22) of a roller set (20) (as shown in FIG. 2). However, an electroluminescent lamp so manufactured is only capable of emitting light of a single color. In order to display multiple colors, numerous manufacturing methods have been proposed:

1. Dyeing method: This is a method by which a transparent resin imbued with a pre-mixed pigment is applied to the outer surface of upper film layer (refers to EP0794689, EP0581232). The drawback to this method is that the resulting electroluminescent lamp can display only a single color and cannot provide for partial coverage or multi-color applications.

2. Filter films color-matching method: This method entails stacking several filter films in the electroluminescent lamp in order to match a proper color pattern based on optical theory. The filter films are of different colors and sizes based on the color and shape of the required pattern. Local intersection methods are used step by step, from bottom to top, from light to dark, to form the desired patterns on the electroluminescent lamp. The drawbacks to this method are that it is limited to single color results and is incapable of producing a “progressive” effect. Moreover, it cannot produce complicated patterns in thinner dimensions (the number of filter films increases with pattern complexity), limiting brightness and flexibility. In addition, the clipping and positioning of the filter films requires tremendous amounts of work.

3. Tracing paper method: In this method, pigments are applied to a translucent tracing paper by plating or spraying, and a pattern is formed by cutting or overlapping the tracing paper. The resulting film is then interposed between the face electrode substrate (121) and the upper protective film (11). Because the tracing paper possesses a specific thickness (including the tracing paper, the color pattern layer, and an adhesive layer), the resulting electroluminescent lamp is limited in both luminance and flexibility.

4. Fluorescent dyeing/printing method: In this method, a pattern is dyed/printed on fluorescent material 123. However, because the fluorescent material of the phosphor layer 123 is not an ideal material for application to a dyeing base, only a limited range of useful colors can be provided by the method and the resulting pattern is of extremely low resolution. Moreover, the production process is very complicated (requiring many steps of applying, dyeing, and drying).

### SUMMARY OF THE INVENTION

The major objective of the present invention is to provide a full-color electroluminescent lamp structure possessing a full-color pattern generated by full-color printing technology on the inside surface of one of the component layers and, beyond this single layer containing the color pattern, requiring no other additional layer or film beyond the basic structure, so that it is thinner, provides for better graphic resolution, and suffers less brightness loss while emitting light to display the color pattern.

The second object of the present invention is to provide a manufacturing method for a full-color electroluminescent lamp with a full-color pattern (produced by full-color printing technology) located on the inner surface of one of its component layers. The process of manufacturing the full-color electroluminescent lamp will thus be simplified and will provide for less brightness loss and better graphic resolution.

The present invention is a full color electroluminescent lamp consisting of an upper protective film, a light-emitting film, and a bottom protective film. The light-emitting film is sandwiched between the upper protective film and the bottom protective film and acts as the light source of the full-color electroluminescent lamp. The light-emitting film includes at least a face electrode substrate, a face electrode layer, a phosphor layer, and a back electrode layer. At least one full-color pattern is formed on the inner surface of one of the component layers of the electroluminescent lamp by full-color printing (e.g., on the inner surface of the upper protective film).

### BRIEF DESCRIPTION OF THE DRAWINGS

FIG. 1 is a cross section of a prior-art electroluminescent lamp structure.

FIG. 2 is an illustration of electroluminescent lamp formation by roller compression.

FIG. 3 is a cross section of a full-color electroluminescent lamp according to the first embodiment of the present invention.

FIG. 4 is an illustration of the display formed by the full-color electroluminescent lamp with a color pattern produced according to the first embodiment of the present invention.

FIG. 5 is a cross section of a full-color electroluminescent lamp according to the second embodiment of the present invention.

FIG. 6 is a cross section of a full-color electroluminescent lamp according to the third embodiment of the present invention.

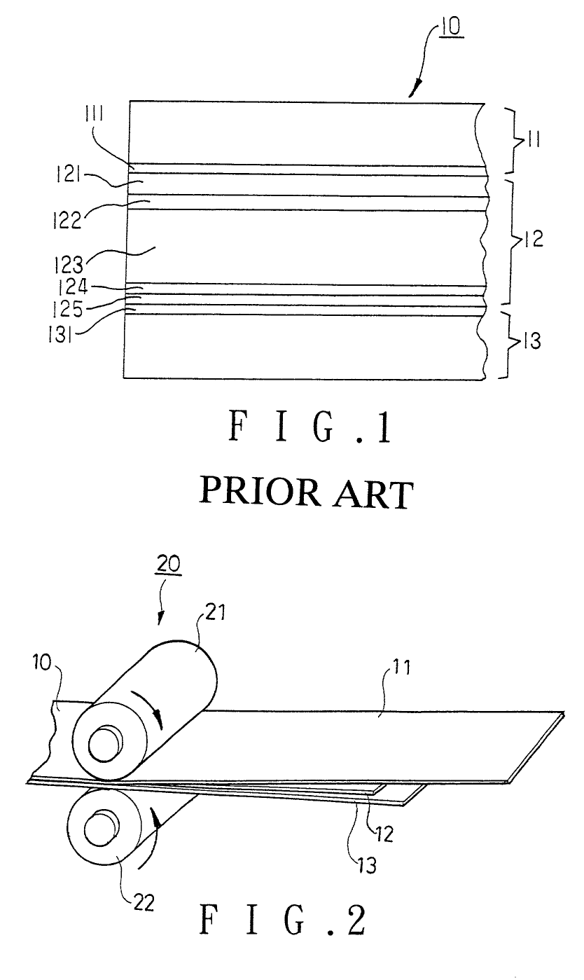

### DETAILED DESCRIPTION OF THE PREFERRED EMBODIMENT

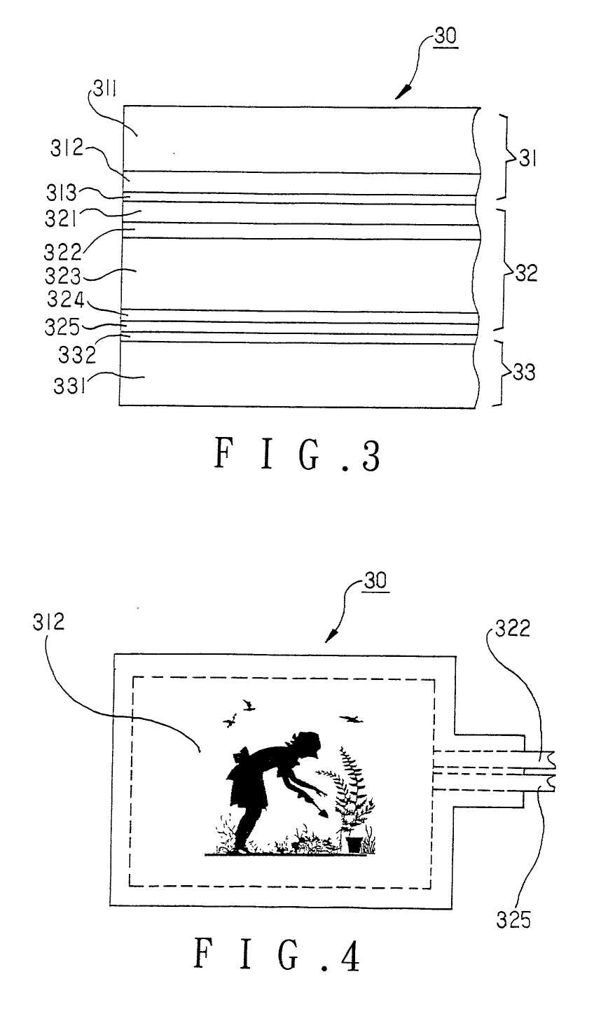

As shown in FIGS. 3 and 4, according to the first embodiment of the present invention, a full-color electroluminescent lamp (30) is formed by compressing an upper protective film (31), a light-emitting film (32), and a bottom protective film (33). The light-emitting film (32) is sandwiched between the upper protective film (31) and the bottom protective film (33) and serves as the light source of the full-color electroluminescent lamp (30). The upper protective film (31) and the bottom protective film (33) provide protection against humidity and dust, and prevent oxidization and attrition of the light-emitting film (32).

The formation of the light-emitting film (32) includes the following steps. A transparent electricity-conductive layer is first spread on the transparent face electrode substrate (321) to form the face electrode layer (322). In order, phosphor, insulation paste, and conductive paste are spread to form a phosphor layer (323), a dielectric layer (324), and a back electrode layer (325), respectively. This light-emitting film (32) then serves as the light source of the full-color electroluminescent lamp (30). The light-emitting film (32) possesses a size corresponding to the upper protective film (31) and the bottom protective film (33). The body of the upper protective film (31) includes a protective layer (311) made of transparent plastic.

In a common electroluminescent lamp, the upper protective filter (31) consists of a protective layer (311) and an adhesive layer (313). In this embodiment, A color pattern is chosen to apply the color pattern to the inner surface of the protective layer (311). First, either a wet full-color (e.g., ink-jet) or a dry full-color (e.g., laser printing, heat transfer, heat sublimation) printing technique is chosen according to the resolution and color quality requirements of the pattern to be produced. Once the printing technique has been selected, a suitable material (e.g., PET, PVC) for the upper protective layer (311) is chosen and subjected to appropriate treatment (to increase pigment adhesion and image resolution). In this embodiment, the full-color pattern (312) is formed on the inner surface of the upper protective layer (311) by first using computer graphics software to design a mirror-image full-color picture (when observed from the outside, the full-color picture becomes the desired full-color pattern (312)), and then employing the chosen full-color printing process. Once the full-color printing process has been completed, the desired full-color pattern is produced. The bottom protective film (33) includes a bottom protective layer (331) made of either transparent or opaque plastic. After applying adhesive (313) and (332) on the inner surfaces of the upper protective layer (311) and bottom protective layer (331), respectively, the upper protective film (31), light-emitting film (32), and bottom protective film (33) are then compressed by a roller set (20) (as shown in FIG. 2) under temperatures of 40-180° C. to form the full-color electroluminescent lamp (30).

As shown in FIG. 4, both the face electrode layer (322) and the back electrode layer (325) possess an exposed external end to the power supply. While supplying alternating current electricity, the electricity field energy between the face electrode layer (322) and the back electrode layer (325) will cause the phosphor layer (323) to emit light. Since the full-color pattern (312) is located between the upper protective layer (311) and the face electrode substrate (321), it is effectively isolated from the phosphor layer (323)(it is not between the face electrode substrate (322) and the back electrode substrate (325)). In this way, difficulties such as those encountered in the fluorescent dyeing/printing method (of controlling the even dissolution of pigment pellets in the fluorescent medium and the local capacitance change caused by uneven distribution of pigment pellets) can be avoided. This provides for a full-color pattern (312) of not only higher resolution and greater color variety, but also of greater overall quality than that provided by the fluorescent dyeing/printing method.

Furthermore, since the full-color pattern (312) in the present invention is printed directly onto the upper protection film (31), only a single full-color pattern layer is added to the basic electroluminescent lamp structure, resulting in an electroluminescent lamp (30) which is thinner than electroluminescent lamps employing multiple color filtering films or layers of tracing paper, thus providing better flexibility and decreased brightness loss.

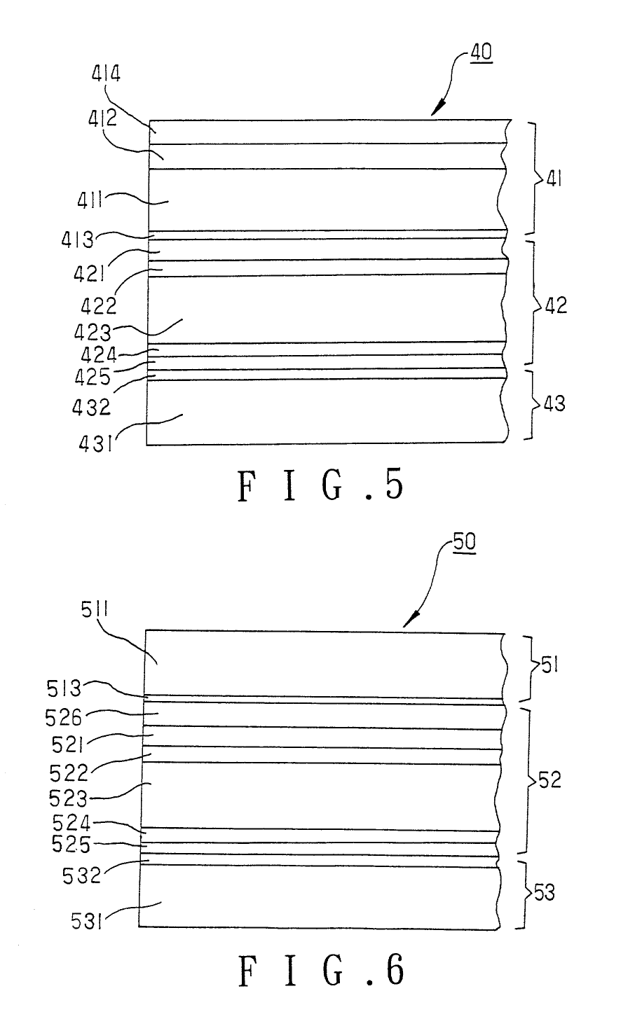

The full-color pattern layer in the present invention is not limited to mirrored patterns printed on the inner surface of the upper protective layer (311). In the second embodiment, as shown in FIG. 5, a correct-image (not mirror-image) full-color pattern (412) is printed on the previously treated outer surface of the upper protection layer (411), which is the body of the upper protective film (41), with all other components remaining the same with the first embodiment (i.e., upper protective film (41), upper protective layer (411), adhesive (413), light-emitting film (42), face electrode substrate (421), face electrode layer (422), phosphor layer (423), dielectric layer (424), back electrode layer (425), bottom protective film (43), adhesive (432), and bottom protective layer (431)). An additional protective layer (414) may also be formed by adding a transparent resin or adhesive layer and transparent protective film to produce a full-color electroluminescent lamp (40). Because the pattern is printed on the outer surface of the upper protective layer, this embodiment allows for greater flexibility in the manufacturing process, as the printing of the color pattern can occur before or after the compressing procedure. First, the pre-processing method is to print the full-color pattern (412) on the outer surface of the upper protective layer (411) before compressing, and then to add an auxiliary protective layer (414) to form an upper protective film (41) with a full-color pattern already present. Then the upper protective film (41), the light-emitting film (42) and the bottom protective film (43) are compressed together to form the electroluminescent lamp (40). In the second process, the post-processing method is to compress the upper protective layer (411), the light-emitting film (42) and the bottom protective film (43) first. Then the full-color pattern (412) is formed on the outer surface of the upper protective film (411) which is already bonded with the light-emitting film (42) and the bottom protective film (43). The pattern may be formed by full-color printing or may be hand-applied by craftsmen or artisans. Afterward, a transparent auxiliary protective layer (414) is applied over the full-color pattern (412) to protect both the full-color pattern (412) and the electroluminescent lamp (40).

Although this method may result in greater thickness and less brightness than the first embodiment, the pattern it produces loses nothing in color range and resolution. Moreover, the flexibility of the manufacturing process means greater ability to meet special market needs.

In the third embodiment of the present invention, all components remain the same with the first embodiment (i.e., upper protective film (51), upper protective layer (511), adhesive (513), light-emitting film (52), face electrode substrate (521), face electrode layer (522), phosphor layer (523), dielectric layer (524), back electrode layer (525), bottom protective film (53), adhesive (532), and bottom protective layer (531)), with the exception of the full-color pattern (526), which has changed position. The surface of the upper electrode substrate (521) which does not meet the surface of the face electrode layer (522) is subjected to suitable treatment and receives the full-color pattern (526), which is printed on its surface to produce a different full-color electroluminescent lamp with the same color range, resolution, brightness, thickness, and flexibility of the first embodiment.

The above detailed description is provided to illustrate specific embodiments of the present invention and does not limit the present invention. Numerous modifications and variations within the scope of the present invention are possible. The present invention is defined by the claims appended herein below.

What is claimed is:

1. A full-color electroluminescent lamp, comprising an upper protective film, a light-emitting film, and a bottom protective film, wherein the light-emitting film is sandwiched between the upper protective film and the bottom protective film, and where the light-emitting film includes at least a face electrode substrate, a face electrode layer, a phosphor layer, and a back electrode layer serving as the light source of the electroluminescent lamp, which is characterized by at least one full-color pattern being formed on one of the inner surfaces of the electroluminescent lamp by one full-color printing.

2. The full-color electroluminescent lamp in accordance with claim 1, wherein the full-color pattern is located on the inner surface of the upper protective layer of the upper protective film.

3. The full-color electroluminescent lamp in accordance with claim 1, wherein the full-color pattern is located on the outer surface of the upper protective layer of the upper protective film.

4. The full-color electroluminescent lamp in accordance with claim 3, wherein the upper protective film further comprises and additional auxiliary protective layer covering the full-color pattern.

5. The full-color electroluminescent lamp in accordance with claim 1, wherein the face electrode layer, the phosphor layer and the back electrode are formed on one surface of the face electrode substrate and the full-color pattern is formed on another surface of the face electrode substrate.

6. A manufacturing method for a full-color electroluminescent lamp, wherein the electroluminescent lamp includes an upper protective film, a light-emitting film, and a bottom protective film, comprising the steps of:
providing an upper protective film which is pervious to light, and upon the surface of which is printed a full-color pattern;
providing a light-emitting film, including at least a face electrode substrate, a face electrode layer, a phosphor layer, and a back electrode layer to serve as a the light source of the electroluminescent lamp;
providing a bottom protective film; and
compressing the upper protective film, the light-emitting film, and the bottom protective film by sandwiching the light-emitting film between the upper protective film and the bottom protective film.

7. A manufacturing method for a full-color electroluminescent lamp, wherein the electroluminescent lamp includes an upper protective film, a light-emitting film, and a bottom protective film, comprising the steps of:
providing an upper protective film which is pervious to light;
providing a light-emitting film, including at least a face electrode substrate, a face electrode layer, a phosphor layer, and a back electrode layer to serve as a the light source of the electroluminescent lamp wherein the surface of the upper electrode substrate which does not meet the surface of the face electrode layer serves as a surface upon which a full-color pattern may be produced by full-color printing techniques;
providing a bottom protective film; and
compressing the upper protective film, the light-emitting film, and the bottom protective film by sandwiching the light-emitting film between the upper protective film and the bottom protective film.
